(19) United States
(12) Patent Application Publication
(10) Pub. No.: US 2014/0074874 A1
(43) Pub. Date: Mar. 13, 2014

(54) METHOD, SYSTEM AND APPARATUS FOR LOCATION-BASED MACHINE-ASSISTED INTERACTIONS

(71) Applicant: Federico Fraccaroli, Irving, TX (US)

(72) Inventor: Federico Fraccaroli, Irving, TX (US)

(21) Appl. No.: 14/044,615

(22) Filed: Oct. 2, 2013

(51) Int. Cl. G06F 17/30

(52) U.S. Cl. CPC G06F 17/30595
USPC 707/758

(57) ABSTRACT

In accordance with one example embodiment of the present invention a method comprises at least partially enabling a set of functionalities and attributes associated to an area for facilitating business transactions, networking activities, or social interactions of users who are within, proximate, or associated, at least provisionally, with said area.

### TECHNICAL FIELD

The present application generally relates to a method, a system and an apparatus for facilitating social interactions and/or professional interactions and/or business transactions.

### BACKGROUND

The teachings of patents U.S. Pat. No. 6,819,919, U.S. Pat. No. 6,542,750, U.S. Pat. No. 7,813,741, U.S. Pat. No. 6,542,748, U.S. Pat. No. 6,539,232, U.S. Pat. No. 6,542,749, U.S. Pat. No. 8,150,439 and U.S. Pat. No. 6,549,768 are expressly incorporated herein by reference in their entirety. The teachings of the following U.S. patent applications, having the same inventor of the present application, are expressly incorporated herein by reference in their entirety: “Method and Apparatus for Mediating Among a Plurality of Profiles Associated with Users Positioned in a Shared Location,” Ser. No. 13/572,617, filed Aug. 11, 2012, “Method and Apparatus for a Principal/Agent Based Mobile Commerce”, Ser. No. 13/541,737, filed Jul. 4, 2012, “Method and Apparatus for Location Based Conditional Offers”, Ser. No. 13/548,944, filed Jul. 13, 2012, “Method and Apparatus for Location Based Networking Sessions,” Ser. No. 13/633,133, filed Oct. 2, 2012, and “Method and Apparatus for Managing Attributes and Functionalities of Predetermined Geographical Areas,” Ser. No. 13/716,168, filed Dec. 16, 2012.

A geofence is a virtual perimeter for a real-world geographic area. It can be generated dynamically as in a radius around a point location such as a bar or a restaurant. A geofence can be also be generated within the perimeter of a physical location. In one implementation, a geofence can be a predefined set of boundaries connecting points expressed by latitude and longitude. Alternatively a geofence can be an area containing points with similar characteristics, e.g., within the radius of an RF-ID reader apparatus.

Geofencing has been made possible especially by the introduction of GPS (Global Positioning System) technology and the miniaturization of electronic components that have made the locationing functionality a standard feature in Mobile Phones and portable electronics in general.

Geofencing can be implemented via many positioning techniques, both indoor and outdoor, such as by means of detection by an RF-ID reader, Wi-Fi, Bluetooth mapping, accelerometers, gyroscopes, altimeters, magnetometers, or led detection modules, just to cite a few examples.

Locationing techniques coupled with mobile telecommunications technology have opened the door to novel, machine-assisted methods for facilitating and conducting business transactions. For example, the above-mentioned application “Method and Apparatus for a Principal/Agent Based Mobile Commerce” discloses a location-based mobile commerce method based on three actors: 1) a user, 2) an agent and a 3) principal. In said disclosure, an agent, e.g. a trusted customer of a certain brand, can be empowered by a principal, e.g. a car dealer for said brand, to represent said principal with deals or offers that have been preapproved by said principal.

Geofencing and location technologies in general, can trigger or inhibit functionalities of location-aware apparatuses. For example, as described in patent U.S. Pat. No. 7,813,741 titled “System and Method for Initiating Responses to Location-Based Events”, a system may provide a response to one or more location-based services applications to supply location-based services, such as email, instant messaging, paging and the like.

In other enactments, systems can make available location-based information and functionalities in various ways, as described for example in patent U.S. Pat. No. 8,150,439 titled “Facilitating user interactions based on proximity.”

All the patents, patent applications and published documents mentioned anywhere in this application are incorporated herein by reference in their entirety. Furthermore, where a definition or use of a term in a document that is incorporated by reference is inconsistent or contrary to the definition of that term provided herein, the definition of that term provided herein applies and the definition of that term in the reference does not apply.

### SUMMARY

According to one aspect of the present invention, a method comprises: 1) creating a session area model-profile associated with an area by selecting at least a subset of all the possible attributes that may pertain to a generic user profile 2) assigning model values to said subset of attributes 3) comparing said model values with the values belonging to the profile of a user for the same said subset of attributes; and 4) generating a correlation score.

Another aspect of the invention comprises a method, a system and an apparatus for interacting with users who are located within an area. Said method, system and apparatus are based on a software module utility that correlates 1) a visual field displaying user A and 2) user A's profile which is contained in a datagram that is stored in a server. A functional visual icon can be superimposed to the live feed of said user A.

Another aspect of the invention comprises a method, a system and an apparatus for displaying active users who are located nearby user A in an active session area. Numerous aspects, embodiments and examples of the invention that can be implemented by a system, a method or an apparatus are set out in the claims and are described in detail in the specifications.

### BRIEF DESCRIPTION OF THE DRAWINGS

For a more complete understanding of example embodiments of the present invention, reference is now made to the following descriptions taken in connection with the accompanying drawings in which:

FIG. 1 represents a simplified version of various embodiments of the invention describing a system.

FIG. 2 represents an embodiment of classes of session zones.

FIG. 3 represents two non-limiting examples of user equipment's screen shots or I/O User Interface status.

FIG. 4 represents a schematic representation of an embodiment of user equipment such as User Equipment 160, 165 or 170. In some implementations, it may also represent a schematic representation of an Administrator Equipment 110 or Fractional Administrator Equipment 111.

FIG. 5 is another non-limiting example of a user equipment's I/O User Interface status.

FIG. 6 is another non-limiting example of a user equipment's I/O User Interface status.

FIG. 7 is another non-limiting example of user equipment's I/O User Interface statuses.

FIG. 8 is a non-limiting example of a Session Zone 190 partitioning method to provide additional and novel functionalities.

FIG. 9 is a non-limiting example of a three dimensional “Geobox”.

FIG. 10 represents a possible embodiment of one aspect the invention pertaining to the correlation of visual indicia of users who are within a session area with those users' IDs and those users' profiles. Said correlation may allow novel and useful applications and functionalities.

FIG. 11 represents a possible embodiment of a flow diagram illustrating a possible embodiment wherein a correlation output between a user profile and a session area model-profile associated to an area affects discoverability of said area by said user.

### DETAILED DESCRIPTION OF THE DRAWINGS

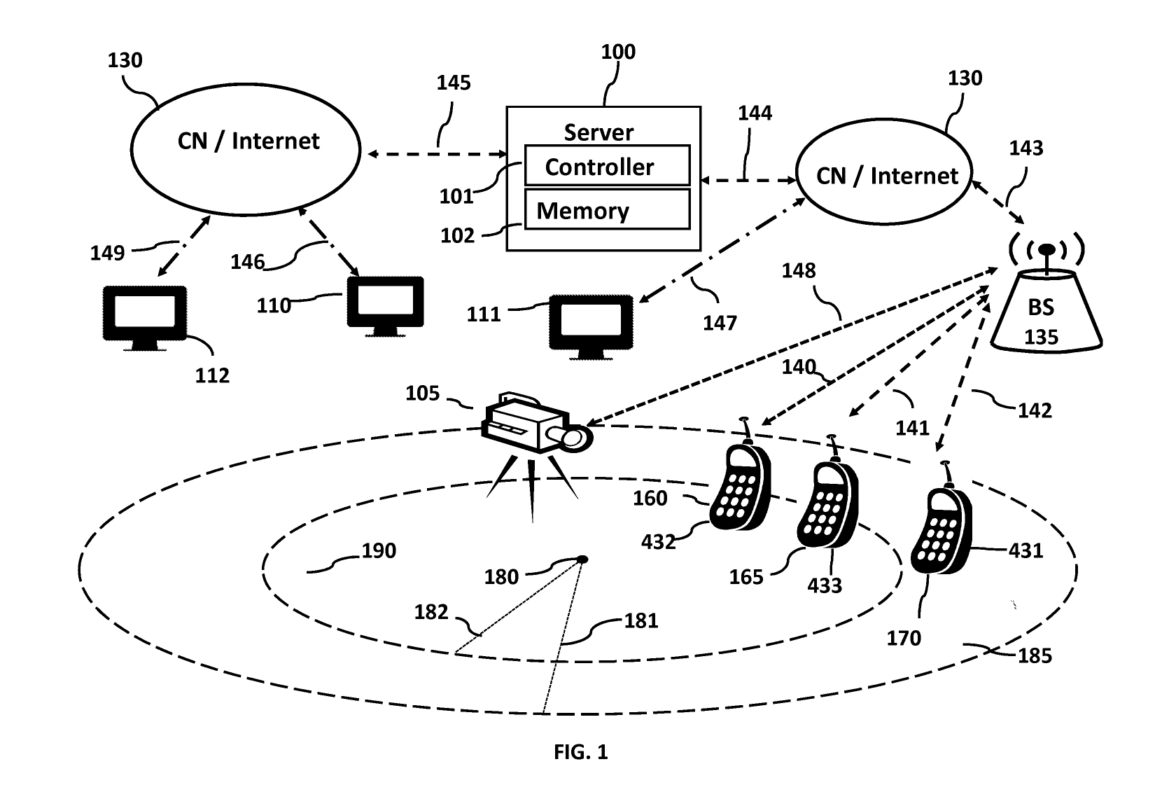

An example embodiment of the present invention and its potential advantages are understood by referring to FIGS. 1 through 10 of the drawings.

FIG. 1 describes one possible embodiment of the invention. User Equipment 170 at time T1 is located in Notification Area 185. Notification Area 185 is a zone, centered on Location 180. Notification Area 185, in one possible implementation, is an area surrounding, non-overlapping and extending beyond Session Area 190. In another, it is overlapping with Session Area 190.

Location 180, in some implementations, can be a public place such as a mall or a bar or a happy hour place. Said public venues may provide an alternative to a business location such as shop, a business office or a dealership that is informal and better suited to a casual and obligation-free interaction.

Session Area 190 is an area, also centered on Location 180 where certain predetermined functionalities are enabled. For example, User Equipment 160 and 165, by virtue of being positioned within Session Area 190 may interact, exchange electronic business cards, or close predetermined business deals.

Because User Equipment 170 is positioned within Notification Area 185 at time T1 and because T1 is comprised within a predefined time window and because User Equipment 170 may contain a software application logged on Memory 431, User Equipment 170 may, for example, receive a notification that a user is located within Session Area 190 and is available for interaction.

In another embodiment, there is no window of notification but notifications can be delivered independently from the time of the day. Said notification can be delivered via Radio Link 142, established between User Equipment 170 and Access Point/Base Station (AP/BS) 135. For the sake of simplicity, in the example of FIG. 1, Access Point/Base Station (AP/BS) 135 is serving all the equipment located in both Session Area 190 and Notification Area 185 via Radio Links 142, 141, 148 and 140.

In one embodiment, User Equipment 170, located in Notification Zone 185, may receive indicia that agent equipment such as User Equipment 160 is located and active in Session Area 190. Said indicia could be related to preferences and settings contained in a data structure determined, at least in part, by a principal.

Fractional Administrator Equipment 111 may represent said principal.

Fractional Administrator Equipment 111 could be one of many principals that are served by an administrator via Administrator Equipment 110. An administrator could be in charge of providing a service to multiple principals in case of a location based service implementing an agency system.

Administrator Equipment 110, connected to the Internet via Link 145 and Link 146 can be representative of, e.g., a provider of the agency service for multiple brands or services. Said service provider may access to the functionalities, software and modules of Server 100 comprising Controller 101 and may serve, e.g., a plurality of principals. Fractional Administrator Equipment 111, connected to the internet via Link 147, may be representative of a particular principal, namely an owner of a service, brand or product for sale who may enable selected agents to participate to a location based service and represent him or her.

Traditionally a principal will control the terms of the offers that agents may extend to users, at least partially. In one implementation, the savings derived by absence of dedicated commercial space and informal, non-traditional marketing realized by a principal can be passed to agents and customers.

A principal may have access, at least partially, to functionalities and settings of Server 100 and may enable agents, compile business offers and regulate the service. Because of analytics-derived or explicit preferences expressed by a user, an algorithm, residing on Memory 102 and running on Server 100, may cause the system to alert user and/or agent of their mutual proximity based on geofences. In another implementation, a user may be able to discover where active agents are, independently from his proximity to them but rather using a browser and a search engine, or filters related to interests, brands or locations.

In one implementation, a user's indicia of interest for a brand or a product via social media activity may consist, for example, of a “like” or ‘share” in a Facebook-type web application concerning a particular brand. In another embodiment, the expression of interest for a particular deal or brand can be the result of an ad-hoc user profile or the result of a user's opting in a notification offering presented to user from time to time via communication media in general.

The person skilled in the art will understand that Facebook is just one of many possible social media platforms where users can indicate interest for particular kind of services, products or brands and that other media services can serve the purpose. Interest or inclinations can also be evinced from contextual information.

User Equipment 160 may contain a software application logged on Memory 432 of the same kind as the one present in User Equipment 170 and 165 on Memory 433 and Memory 431. If User Equipment 160 represents an agent while User Equipment 165 and 170 represent possible target users (who have somewhat expressed an implicit or explicit interest for the brand or service represented by said agent), instead of having a contemporaneous movement of both agents and users around town, an agent can position himself within Session Area 190 and use the system to notify said target users.

The person skilled in the art will understand that the agency model is just a non-limiting example that is provided to illustrate the potential of this invention and many of the concepts can be reused across different industries.

In one implementation, User Equipment 160 can be representative of a professional looking forward to extend the reach of his office or a generic user who is looking forward to interactions with other fellow users for networking or dating purposes. For example, Notification Area 185 and Session Area 190 may support a networking service such as LinkedIn. In this embodiment, user A may express interest in a ‘target” user B and user A can be alerted of the presence of said “target” user B when said user B is within Session Area 190 if security and privacy settings of the system so allow.

In another scenario pertaining to a different industry, Notification Area 185 and Session Area 190 may augment dating services such as Match.com, PlentyofFish, Zoosk, eHarmony or others. The philosophy supporting the case of a dating service can be similar to the previous example of an agent/principal system.

In the case of a dating service, when allowed by the privacy policies, settings, and regulations pertaining to said service, users can be alerted of each other or can interact with each other if certain conditions are met.

Interactions and notifications can also be made possible by software applications and data logged on Memories 431, 432, 433 and 102. The person skilled in the art will understand that software applications and a system based on login and passwords will make equipment interchangeable. As long as the equipment described in this application can host and run a software application or modules of a software application that can enable the system to run and perform the functions described in this application there is no need for dedicated hardware equipment.

In another embodiment, there is no dedicated software application logged on said memories and equipment and said interactions and functionalities can be made possible by a client terminal code executed within a web browser or other application execution environment such as HTML/JavaScript or Flash.

User Equipment 170, 165 and 160 can be a mobile phone, a PDA, a laptop, or a tablet or any other wireless mobile device or wearable equipment as long as capable of connecting with the Internet.

In the particular embodiment of FIG. 1, Session Area 190, represented as having a circular shape with Radius 182, is centered on Location 180. Session Area 190 can be an area where mobile equipment such as User Equipment 160 and 165 can report their presence manually or automatically and be part of a location based group session event. Notification Area 185 can be an area where User Equipment 170 reports his presence manually or automatically. In some implementations, said Location 180 can be, e.g., a bar, a mall, a happy hour place or other place where access is restricted such as a conference room in a business building, a hotel or a convention center, or a private household.

In some implementations, the session area will be permanently active and the event shall be permanent. In other instances, the event can be recurring, e.g., every Tuesday form 4.00 PM to 8.00 PM. In other implementations, the event can be a one-time event.

The advantages that can be afforded to users within Session Area 190 can be multiple. As non-limiting examples, if Server 100 has received the information that User Equipment 165 is within Session Area 190, then Controller 101 may facilitate the browsing and the retrieving of user profiles associated with users who also are within said Session Area 190 such as User Equipment 160. It may also regulate the possibility of interacting via a messaging system or other predetermined interaction system such as an expression of interest notification.

Controller 101 may also regulate business transactions or preliminary agreements based on location. In one implementation, with reference to the previously described principal/agent system, a principal/agent transaction can be inhibited outside predetermined areas such as Session Area 190.

In one implementation, indicia of the presence of certain users within certain session areas can be made available to other users, such as External User 112 that is connected to Server 100 via Link 149, according to certain preferences. For example, in certain settings, it can be advantageous for a user who desires to be contacted by people outside Session Area 190 to let other users know of his presence within Session Area 190 even when those people are neither within Session Area 190 nor within Notification Area 185. A user like External User 112 can be browsing in real time the swarm of users who are within Session Area 190. He can do so by means, for example, of a video and/or audio feed from Video Camera 105 that can be accessible via a web page.

In one implementation, External User 112 is able to see the whereabouts of Session Area 190 by using Video Camera 105 that is connected to Server 100 via Link 148 and is able to see and connect to other users who are located there. In one implementation the position of User Equipment 160, 165 and the position of Video Camera 105 is known by the system with accuracy by using, e.g., the technology described in patent application US 20100295943 A1 titled “Real-time RF-ID positioning system and method, repeater installation method therefor, position confirmation service system using the same”.

The person skilled in the art will understand that this is just one of the many examples of possible positioning methods. Other methods or concepts can be utilized such as GPS, Choke point concepts, Grid concepts, Long Range Sensor concepts, Angle of Arrival concepts, Time of Arrival Concept., Received Signal Strength Indication concepts, Inertial Measurements concepts.

In one implementation, Video Camera 105's visual field is correlated and mapped against the position of the users who are within said visual field. The system can generate ID Icon 1005 and ID Icon 1004 that can be superimposed on top of Video Camera 105's video feed so that ID Icon 1005 and ID Icon 1004 can overlap with, e.g., the image of the users of User Equipment 160 and 165. In one implementation, the dimensions of said icons are proportional to the distance of the associated users from Video Camera 105.

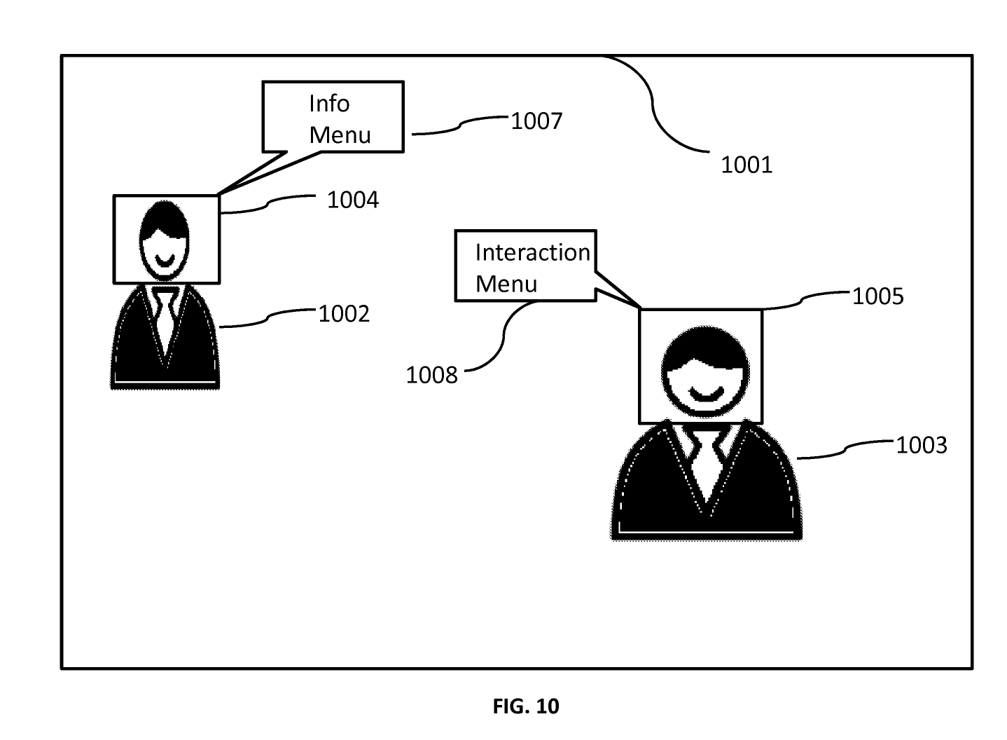

In another implementation, users can simply be wearing an RF-ID bracelet within Session Area 190 so that ID Icon 1004 and ID Icon 1005 can be generated by the system and associated with profiles and datagrams stored on Server 100. This will be explained in more detail with reference to FIG. 10.

Digital information from and to User Equipment 160, 165 and 170 can be communicated via an Access Point/Base Station (AP/BS) 135 to Server 100 via Links 140, 141, 142, 143, 144 and Core Network/Internet Cloud 130. Links 143, 144 and 145 can be radio links or any physical means capable of transporting digital information, including cables.

Communications between User Equipment 160, 170 and 165 can occur via a core network infrastructure supporting any cellular standard. In some embodiments, the exchange of data may occur by means of non-cellular standards such as Wi-Fi or Bluetooth technology. For example, User equipment 160 and 165 could use an ad-hoc Wi-Fi connection and communicate directly without the support of any cellular network.

FIG. 1 represents just one of the many possible embodiments of the present invention. In fact, Session Area 190 and Notification Area 185 could overlap or be far away from each other so that a plurality of different access points or base stations (AP/BS) could be needed to serve User Equipment 170, 165 and 160 in different areas. Moreover, Session Area 190 and Notification Area 185 could be defined not only by means of geofencing but also by many other techniques, for example, the range of the radio communication link type employed by Access Point/Base Station (AP/BS) 135 or the range of an RF-ID reader or even physical walls or fences coupled with any system apt to detect the presence of a user within said walls or fences such as an RF-ID reader or an Indoor positioning systems (IPS).

Furthermore, the radio link employed by Access Point/Base Station (AP/BS) 135 could be of many different types, e.g. Wi-Fi, GSM, WCDMA, LTE, CDMA, RF-ID and Bluetooth, just to cite a few non-limiting examples. Location can be provided by many different techniques, for example triangulation with different Access Points/Base Stations, cell ID, signal strength data mapping of various Access Point/Base Stations (e.g., Wi-Fi positioning).

Indoor positioning systems (IPS) are rapidly evolving. Instead of using satellites, an IPS may rely on nearby anchors that are nodes with a known position, which either actively locate tags or provide environmental context for devices to sense. The current localized nature of an IPS may involve different systems making use of various optical, radio, or even acoustic technologies.

For the purposes of the present application, Session Area 190 should be interpreted broadly and consistently with the advances of technology in the area of locationing techniques. In one implementation, Session Area 190 may extend beyond the physical location of a building such as a bar or a mall, for which Location 180 could be a proxy. In another implementation, Location 180 can be centered on the instantaneous position of user equipment and be activated by said particular user equipment without any reference to a physical building or establishment.

In another implementation, Session Area 190 may be contained within the perimeter of a building and an indoor positioning system may define its boundaries. In another implementation, the boundaries of Session Area 190 can be defined by the physical walls of a room in a building coupled with a system to detect presence of a particular user within those walls. An RF-ID system may provide both a presence detection function and an identity discovery function of a user within said walls.

In another embodiment, a facial recognition system coupled with a movement detection system may provide the identity of a user entering a particular room and the element of presence in said room. Said facial recognition system may generate an ID coupled with a user because of a comparison with data contained in a database storing facial features of possible users. Said facial recognition system may provide said ID to Server 100 to account for the presence of said user within the physical location area served by said facial recognition system.

In one implementation, Session Area 190 can be in at least two different statuses: active and passive. During an active status, mobile equipment positioned within notification or session zones and logged on Memory 102 of Server 100 as within Session Zone 190 may be able to show profiles or permit interaction with other users who also are within Session Area 190. Session Area 190 can also be “always on” meaning in a permanent active status. Session areas may be subject to time windows wherein said time windows, that might be recurring or a one-time occurrence, may regulate the enabling or disabling of certain functionalities.

In another implementation, certain thresholds pertaining to said session areas might regulate functionalities afforded to user equipment. For example, only a set amount of users can be allowed by the system to become visible, e.g., the first one hundred users logging into Session Area 190. Users who are in excess may populate a waiting list.

Users' visibility may also be subject to timers or threshold rates. For example, the rate at which a user interacts with other users may influence visibility, prominence, or discoverability within Session Area 190 or notification Area 185. For example, users within Session Area 190 can be required to interact with at least a minimum number of other users within a certain period to remain visible.

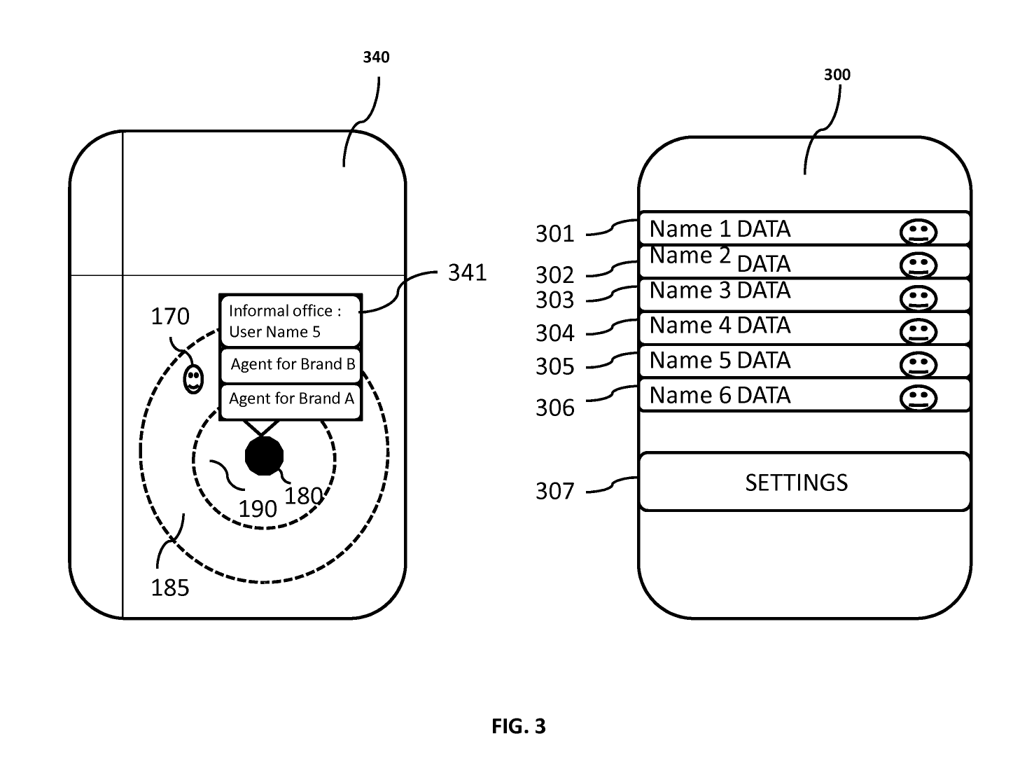

In another implementation, the rate of interaction with other users within the session area may affect their discoverability. Said impact may be positive or negative according to possible settings of the server provider. User's visibility can be inhibited or diminished by said system's settings. A diminished visibility may correspond, e.g., to the dropping of a user's profile toward the bottom of a list of users such as the one described in FIG. 3 in Screen 300.

In one implementation, users can also be subject to timers so that, if they do not accomplish some task that is regulated by the system within a time threshold, their visibility or other functions can be inhibited or limited. The system may act in various ways and, for example, instead of “punishing” users for their inactivity it may promote the visibility of users with the least amount of interactions or activity.

In another implementation, a user can be afforded only a restricted number of possibilities for interactions with other users. For example, a user in Session Area 190 may only be able to send a number N of requests for interactions during an active session time window. This can be done to avoid tragedy of the commons problems and regulate the quality of the interactions.

In another implementation, an algorithm running on server 100 may regulate the rate at which a certain user within Session Area 190 is asked to interact. For example, if the system notices that a certain user A is asked to interact above a certain threshold within a certain time window it may prevent user A to receive mass notifications and send a message back to interaction requester that a certain threshold has been reached. The algorithm may also space interactions requests in time or rearrange interaction requests according to certain priorities and criteria such as premium subscription, time spent within the session area, recurrence within the session area, or usage of the application, just to cite a few examples.

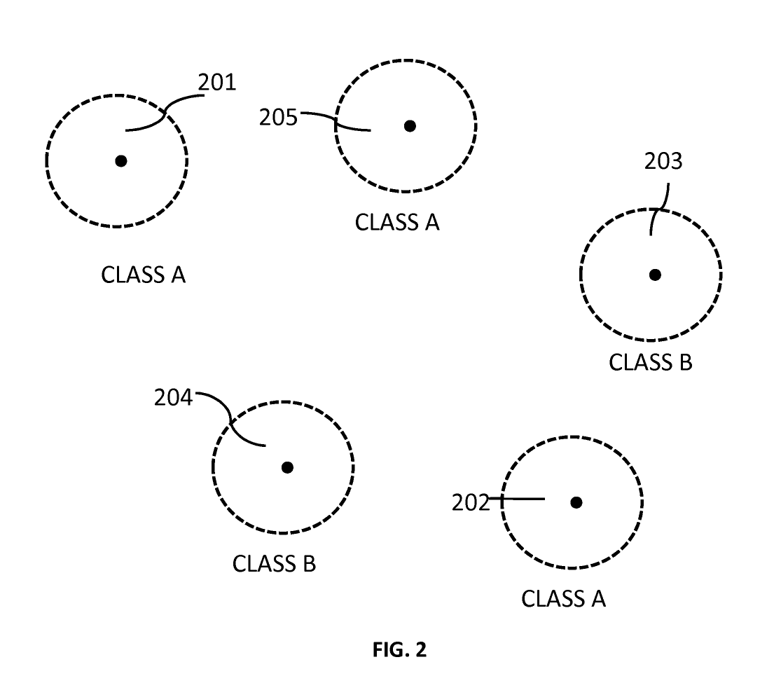

FIG. 2 represents examples of session areas, such as Session Area 190, or notification areas, such as Notification Area 185, having different properties and functionalities. Said properties and functionalities can be used to classify said areas. For example, Class A session areas such as Area 201, Area 202 and Area 205 can be areas centered on public places such as restaurants and bars dedicated to affluent professionals and having a high price range for their food and services. Class A session areas can be used for networking activities. Class B areas such as Area 203 and Area 204 can be areas centered on public places such as restaurants and bars dedicated to a younger and more informal clientele and having a more affordable price range for food or services. Class B session areas can be used, e.g., for dating and activities that are more informal.

In one implementation, if a system of classes for session areas is implemented, and session areas are classified according to certain parameters that are known to users, users can choose which in session areas to attend and where to become visible automatically without interacting with the system. They can do so by choosing a class of session areas or, alternatively, by handpicking certain session areas that they feel comfortable with or they deem useful or safe.

Certain session areas can also be associated to LinkedIn groups or other social media groups members such Facebook groups.

The person skilled in the art will understand that the possibilities are extremely numerous. For example, in a dating service scenario, session areas can be classified according to classes of users using biographical data of target users. Session areas classes can be dedicated to users who are within a certain age bracket or to users who have been divorced or users with children. Individual users, a service provider or both, may control, at least partially, properties and functionalities assigned to session areas.

Session areas that are hosting recurring events can be dedicated to certain kind of professional categories and can be classified accordingly. Session area classifications can be extremely various. Classifications may pertain to functions to which session areas or events are dedicated. A one-time event or a recurring event can be particular time windows served by a particular session area for fulfilling a predetermined function, e.g. networking. As a matter of example, certain session areas can be classified as “professional networking”, others as “dating”, and others as “job hunting”, and others as “sales according to the principal agent location based method”. The person skilled in the art will understand that a functional classification system may grow in time, as new functions will emerge according to the evolution of business practices and societal customs.

An example of functionality that in certain implementations a user can control is privacy. A user may decide in which session areas he wants to become visible 1) automatically, 2) manually, 3) upon a request from the system, 4) according to certain settings, or 5) never.

A user may elect to turn visible or invisible in certain session areas according to certain parameters and thresholds. For example, the contemporaneous presence of another predetermined user in a session zone may influence visibility settings. A threshold concentration of a particular profile attribute may influence visibility settings. A sudden concentration of doctors in a session area may cause a user's profile belonging to a user within a session area to become visible.

In another implementation, session areas can be dedicated to a particular specific profile's trait. For example, certain session areas can be dedicated to a specific professional figure such as doctors, and those session areas can be used for various activities such as networking, dating, sales, recruiting, demonstrations et cetera. Profiles may have time windows of visibility, e.g., a time during the day or a day during the week when a profile is set to be visible. Profiles may also have spatial windows of visibility, e.g., a profile may only be visible in geofences that are located in places that are at least a hundred miles from a reference point, for example home.

In one implementation, a session area may be associated to a session area model-profile stored in Server 100. Said session area model-profile may consist of a profile that is representative of the user or users who are the target or a benchmark for a particular session area or event that is hosted within that session area.

A user profile, in one embodiment, is a collection of data, preferences and settings defined by a common set of attributes describing characteristics or traits that will apply to a user, at least partially. For example, a user can be described in his profile by a set of attributes that could include Religion, Race, Age, Education, Citizenship, Title, Age, Industry, Profession, Sexual Orientation or Premium User.

A session area model-profile, in one implementation, is a set of possible attributes that may pertain to a user profile wherein said attributes have been assigned a specific value or descriptive term. A session area model-profile, in another implementation, is a subset of all the possible attributes that may pertain to a user wherein said attributes have been assigned a specific numerical value or a descriptive term, (e.g. Industry: Information Technology and Services). In one implementation, descriptive terms may be restricted to a finite number of options to be selected from by using, e.g., a drop down menu.

In another implementation, the subset may even be one single attribute that has been assigned a desired value or descriptive term (e.g., Premium User). In one implementation, a “specific value” is a numeric attribute such as Age, Time Spent in the Session Area, Salary, Credit Score, and Desired Age for a Possible Date or else. In one implementation, a “descriptive term” is a descriptive attribute such as “Gender” or “Occupation”.

For the purposes of this application, unless otherwise specified, a numerical value or descriptive term pertaining to an attribute in a user profile datagram or pertaining to an attribute in a session area model-profile datagram can be simply referred to as “value” of said attribute independently from its class (descriptive or quantitative).

In one implementation, certain attributes pertaining to a session area model-profile can be critical attributes. For example, if critical attributes that have been assigned values in the session area model-profile are not met by values in a matching set of attributes in the profile of a user, the resulting correlation output might be zero or a low value.

For example, a critical attribute could be a field that describes a premium user in the profile so that only premium users will have a correlation score or produce a correlation output different from zero. In another example, a critical attribute could be a code pertaining to an event so that only those users knowing the code and having input said code in the pertinent attribute field would be correlated. In some implementations, the code can be unique to the user. In other implementations, the code can be unique to the event or the session area. In certain implementations, only users who know a unique code will be able to discover the event or the session area.

In one implementation, not all the attributes in a user profile might be under the complete control of the user. Certain attribute values or descriptive terms can be fixed or semi-fixed once a user inputs them for the first time, such as the date of birth. Other values for certain attributes can be derived independently by the system to avoid users manipulating their profiles in order to seek a higher correlation output with certain session area model-profiles or event model-profiles. In another implementation, a certain attribute value can be the result of interactions with other users. For example, the sum of positive feedbacks and negative feedbacks from other users might generate an attribute value that can be used to correlate a user profile with a session area model-profile or event model-profile.

A session area model-profile, in one implementation, can be the target or reference profile that a particular session area or event hosted by said session area is trying to attract or promote or benchmark. For example, an event can be targeting doctors, who are 30 years old and single. Profiles of users who are within the session area can be ranked according to their degree of proximity to said session area model-profile.

An event or a session area may have more than one session area model-profiles, e.g., one for males and one for females if ,for example, the event is a dating event hosted by companies such as Match.Com, eHarmony, Zoosk, OurTime or the like. In one implementation, not all the attribute values or descriptive terms of the session area model-profile are made public by the service providers.

In one embodiment, an attribute is an element of data that, when defined, describes one aspect of a user. Said attributes may be contained in a datagram stored, for example, on Memory 102 of Server 100. Attributes of a user can be used by the system to establish a degree of correlation score (or correlation output) between a particular session area model-profile and a profile of a user who, for example, is located within that session area. In another embodiment, said degree of correlation can be calculated for users who are outside said session area. A high value of correlation output could give a remote user such as External User 112 some privileges and functionalities associated with said session area as the privileges and functionalities described with reference to FIG. 10. For the purpose of this application, “degree of correlation” and “correlation output” can be used interchangeably.

In one embodiment, the degree of correlation between two items can be measured by a correlation algorithm that assigns a numeric value to each of the similarities found between said items' correlation attributes. Said algorithm can use weights such as numeric values that are used to modify a degree of correlation score between said session area model-profile and said user profile. By using weights, certain attributes of a user profile may have more sway in determining the overall correlation score with a particular session area model-profile. For example, if Age is a critical attribute, Age can be associated with a higher weight attribute, e.g., a value between one and two. If Age is not a critical attribute, it may be associated with a lower value, e.g., between zero and one. If Age is a neutral attribute it may be associated with a weight attribute equal to one. Said algorithm stored, for example on Memory 102 of Server 100 may rank users' profiles according to their degree of proximity or distance from said session area model-profile.

In one implementation, said ranking based on degrees of distance from said session area model-profile can be used to affect users' visibility. For example, with reference to FIG. 3, Users 301, 302, 303, 304, 305, 306 can be listed and ranked according to said degree of correlation score. Users at the top of the list, such as User 301, may have a profile that is more correlated with the session area model-profile while users who are at the bottom, such as User 306, may have a profile that is less correlated with said session area model-profile.

In this application, the term “visibility” shall mean the degree of prominence of a particular user profile or session area in comparison to other users' profiles or other session areas generated by the system. In the contest of this application, the term “discoverability” shall mean a discrete status afforded to a particular user profile or a session area. In one implementation, a user associated with a user profile or an area associated with a session area model-profile are either discoverable or they are not discoverable. If they are not discoverable, their visibility shall be zero. If they are discoverable, their visibility may vary according to various degrees. For example, users or areas may top a list or may be at the center of a graphical representation if their visibility is high.

In one implementation, the degree of correlation between a session area model-profile and the profile of users can be used to allow discoverability or regulate the visibility of certain session areas that have been assigned, (either temporarily or periodically in conjunction with an event or permanently), a session area model-profile. For example, with reference to FIG. 2, only those users whose profile produces a minimum preset degree of correlation output with the session area model-profile assigned to Area 203 will be able to discover said area. In a dating scenario, certain areas might be discoverable only by users whose profile fits certain criteria, e.g., one attribute value in the event model-profile is set to “previously divorced” or “never previously married”. Only those users whose profile fits that attribute will be able to discover and join the area associated with said event model-profile for interactions with other users.

In another implementation, an algorithm stored in Memory 102 may permit visibility to a profile only if the attributes associated with said profile are within a predetermined proximity range to said session area model-profile. For example, those profiles whose attribute Age is more than five years apart from a reference value contained in said session area model-profile may result in being hidden or not allowed to become active within the session area.

In certain implementations, the system may allow only users having profiles that are within predetermined boundaries of said session area model-profile, at least for some critical attributes, to become active in said area, discover said area, or perform certain functions within said area.

In one implementation, an algorithm may regulate certain functionalities or privileges afforded to users within the session area according to said degree of correlation score with the session area model-profile. It can do so hierarchically by comparing profiles of users associated with said area while providing the limited functional resources that are associated with the area only to profiles belonging to a top tier.

In one exemplary situation, the system may compare the credit score associated with a certain user with a “session area model credit score attribute”. The system may allow the discoverability of that area only to users with a credit score above (or below) said model attribute. The system may also allow the possibility of performing certain functions associated with that area based on credit score. For example, in case of a principal-agent transaction, only users with a certain credit score might be able to discover agents or areas associated with agents or close business transactions within those areas.

The person skilled in the art will understand that what in this application has been often labeled as “session area model-profile” is not intended to be limited to a permanent profile associated with a location but rather multiple session area model-profiles can be created, even temporarily. For example, multiple session area model-profiles can be created and they can coexist within the same session area. For example, male profiles can be correlated against session area model-profile “ONE” and females can be correlated against session area model-profile “TWO”. In one implementation, multiple session area model-profiles coexisting in time and space within a session area can be linked together to allow users whose profile correlates with at least one of those session area model-profiles to interact.

In one implementation there could be a waiting list system implemented wherein only a certain predetermined number of active users could be allowed to become active. The system may give priority to those users whose user profile fits the session area model-profile most closely.

In another implementation, the system may operate according to a best effort scenario and allow visibility or discoverability of an area or an event to a predefined number of users wherein those users are the ones who fit the session area model-profile most closely based on their real time location or other reference location.

In another implementation, the system may correlate profiles of users who are logged into a session area among each other using said attributes and may generate a correlation score representative of the correlation of one profile against the other. In a visual or graphical representation of said users, similar users may appear proximate to each other and navigation between profiles can be more efficient.

There are numerous patents and applications describing correlations and visual representations of objects and attributes of those objects such as U.S. Pat. No. 7,689,525, U.S. Pat. No. 8,296,667, U.S. Pat. No. 5,986,673, U.S. Pat. No. 6,801,229, U.S. Pat. No. 6,486,898, U.S. Pat. No. 7,120,646, U.S. Pat. No. 7,343,365, US 20070214179-A1, US 20070234234-A1, 20080163118-A1, U.S. Pat. No. 7,792,868 and US 2010038279-A1. They are all incorporated by reference in their entirety.

FIG. 3 represents two examples of user interface screens pertaining to User Equipment 170, 165 or 160. The person skilled in the art will recognize that, as technology advances, similar information can be conveyed by different means, e.g. via an augmented reality equipment or it can be displayed on surfaces by a projector module or by using other technologies.

Screen 340 represents a map showing Location 180, the position of User Equipment 170, Session Area 190 and Notification Area 185. In one implementation, Label 341 may indicate that an agent for brand A is available at Location 180. In another implementation, Label 343 may indicate that user Name 5 is available for informal interactions pertinent to his professional practice, e.g., Family Law via his informal office that is set at Location 180. In certain implementations, said features, visibility and notifications may be premium features paid for, e.g., agent for Brand A, or Brand A's owner or user Name 5.

In one implementation, features and notifications may be dependant from analytics such as average usage of the mobile application by, e.g., user Name 5 or Agent for Brand A. In another implementation, said features and notifications may be dependant from analytics of permanence of Agent for Brand A or User Name 5 within Session Area 190. For example, if more than one agent is present in Session Zone 190, the one that would get priority visibility (or visibility at all) would be the one whose permanence's analytic indicate a stronger connection with the Session Area 190 or Location 180.

Screen 300 of User Equipment 165 may represent a list showing visible users within an active session area that is centered on top of Location 180.

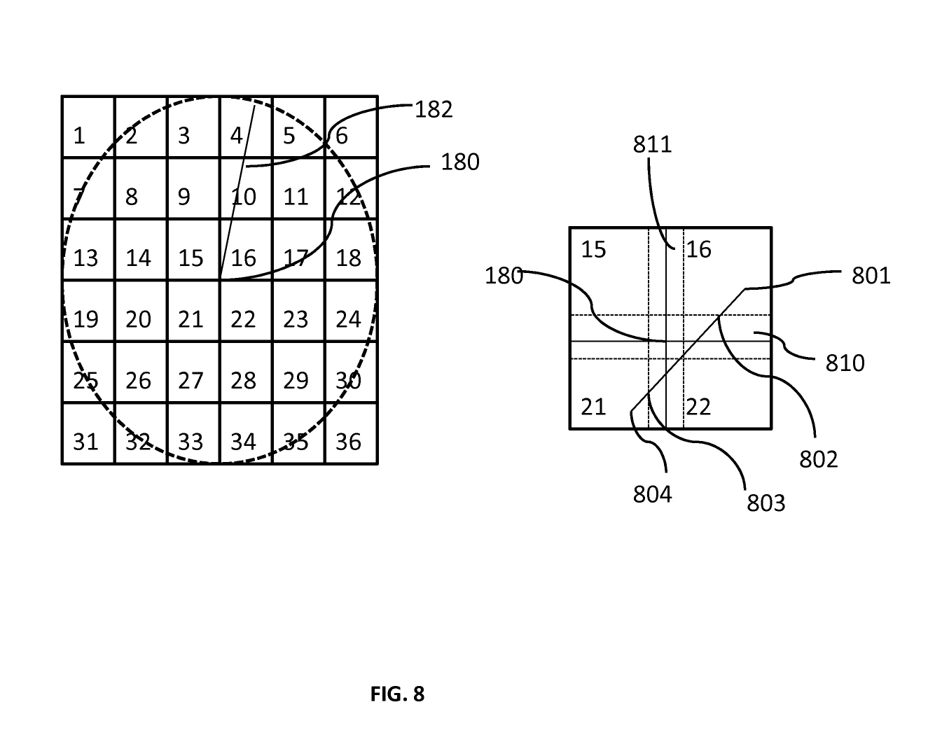

In one implementation the list of Users 301, 302, 303, 304, 305, 306 can be arranged according to analytics related to the usage of the mobile application: the users who use the mobile application the most will be on top of the list. In another implementation, the list can be arranged according to premium users. In another implementation, the list can be arranged according to permanence within the Session Area 190, either during the active session or statistically over time. In another implementation, the list can be arranged according to distance from user of User Equipment 165 using, for example, the method that will be illustrated in FIG. 8. In another implementation, the list can be arranged according to positive feedback from other users who have interacted with them. In another implementation, the list can be arranged according to a correlation score between a session area model-profile and the profiles of active users. Users with a higher correlation score could be at the top of the list.

In another implementation, users would not be arranged according to a traditional list but rather graphically around a particular user on Screen 300 using, e.g., icons. In one implementation, said central user could be the most proximate to said session area model-profile. In another implementation, active users' icons can be arranged around a particular user icon that user of User Equipment 165 has selected. Distances on Screen 300 between icons can be representation of said correlation scores among profiles. The closer two icons are and the higher the correlation between the profiles of the users they represent.

In a possible implementation, user A will be able to store into a web account (e.g., on a cloud service that is connected to a mobile application running on his User Equipment 160 or 165) electronic business cards related to other users who have been within Session Area 190 during an active event or were within Session Area 190 contemporaneously to user A. The electronic business cards can be automatically generated electronically by using selected fields of social media profiles such as LinkedIn, Facebook or other. In one implementation, the system may allow electronic business cards to be stored only temporarily for a certain period. User A might have to validate the preservation of those business cards manually by selecting and parsing them from his web account.

In a possible implementation data pertinent to Users 301, 302, 303, 304, 305, 306 may display locations such as Location 180 that are statistically and analytically relevant to those users. For example, if User 301 is a regular in a particular location or has an informal office there, said location may appear as part of his profile. The person skilled in the art will understand that data, or profiles in general, may be retrieved via a mobile application as depicted in FIG. 3 or via a web browser or other application execution environment such as HTML/JavaScript or Flash.

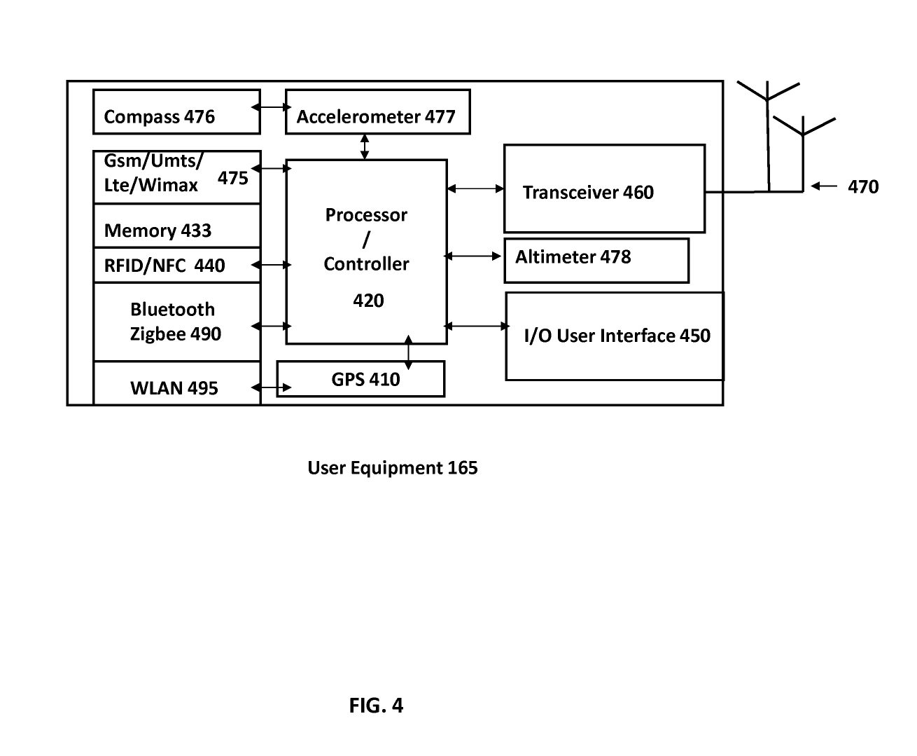

FIG. 4 provides a schematic example of a User Equipment 165 apparatus in accordance with an embodiment of the present invention. In a possible implementation, User Equipment 165 can be substantially similar to User Equipment 160 and User equipment 170 and the generic description of User Equipment 165 can be applicable. In addition, Administrator Equipment 110 and Fractional Administrator Equipment 111 can also be mobile equipment and a similar description may apply.

As described above, the person skilled in the art will recognize that, by virtue of a possible log in mechanism, users may use various equipment as long as said equipment is running a software application contained, e.g., in Memories 431, 432 and 433 and enabling the functionalities described in this application. In practice, the using of a login and a password to access and run a software application stored on equipment makes said equipment interchangeable. Also, as previously described, the system may not need any resident software on Memories 431, 432 and 433 but rather user equipment may work via a web browser or other application execution environment such as HTML/JavaScript or Flash.

User Equipment 165 is a general example of a mobile device that users can operate. It could be a traditional mobile phone, a personal digital assistant, a laptop computer, an e-book reader, an entertainment console or controller, wearable hardware such as augmented reality headsets, a tablet computer or any other equivalent portable device that may be used to communicate with other mobile equipment or with Server 100.

User Equipment 165 includes at least one Processor/Controller 420 and at least a Memory 433 comprising computer program instructions. The at least one Processor/Controller 420 can be embodied by any computational or data processing device, such as a central processing unit (CPU) or application specific integrated circuit (ASIC). The at least one Processor/Controller 420 can be implemented as one or a plurality of controllers.

Memory 433 may contain application software running on User Equipment 165. Memory 433 may also contain at least portions of datagrams that are most relevant to the location, period, and profile associated with said User Equipment 165 at a certain moment in time. Complete datagrams related to profiles, preferences and settings could be stored on Memory 102 of Server 100. In one implementation, user equipment can retrieve and store portions of said datagrams to expedite the system's performances according to various parameters such as location, time windows, user settings and preferences. The at least one Memory 433 can be any suitable storage device, such as a non-transitory computer-readable medium. For example, a hard disk drive (HDD) or random access memory (RAM) can be used in the at least one Memory 433. The at least one Memory 433 can be on the same chip as the at least one Processor/Controller 420, or may be separate from the at least one Processor 420.

The computer program instructions may be any suitable form of computer program code. For example, the computer program instructions may be a compiled or interpreted computer program. The at least one Memory 433 and computer program instructions can be configured to, with the at least one Processor/Controller 420, to cause a hardware apparatus such as, User Equipment 165 to perform any process described herein.

User Equipment 165 may include a Radio Frequency Identification (RFID) and/or a Near Field Communication (NFC) Module 440 with an antenna. The RFID/NFC Module 440 may operate using traditional RFID frequencies or NFC frequencies. In one implementation these RF-ID/NFC Modules 440 contained in User Equipment 165 may send a wireless digital identifier (ID) associated with a user to an RF-ID reader located on the premises of Location 180, a happy hours place, a restaurant, a business building or a private home, for example.

An algorithm located on Server 100 may automatically check-in User Equipment 165 that could be associated with said wireless digital identifier (ID). An algorithm residing on Server 100 can associate said wireless digital identifier (ID) to data structures residing on Server 100 containing profiles, attributes, settings and preferences associated to said wireless digital identifier (ID).

A check-in made by means of an RF-ID reader can also be used in combination with Compass 476, Altimeter 478 and Accelerometer 477 to provide an accurate tracking of the position of users via inertial measurements within enclosed premises where a GPS module or other locationing systems may not work or be sufficiently precise.

In one implementation, if the range of the RF-ID reader is short, e.g., two feet, the system may use the position of the RF-ID reader as the position at the time T of check-in. The system may also use Accelerometer 477 and Compass 476 to track and record any subsequent movement of User Equipment 165 for at least the duration of the active session.

A session area may have more than one RF-ID readers inside an event area so that positions of users can be updated every time user equipment passes nearby one of these RF-ID readers. By comparing the estimated position with a map and by updating the position with numerous fixes via intelligently distributed RF-ID readers the system may maintain a precise position data of particular user equipment over time.

A precise indoor positioning system and Compass 476 can be used to implement a function that can be desirable in crowded venues. For example, if a user requests a meeting with another user within Session Area 190 and said meeting request is accepted, it is desirable that I/O User Interface 450 produce an indication of where the other user is located. If the location of the two users is known with a good level of precision by the system or by a software module running on Memory 431, I/O User interface 450 may produce indicia such as an arrow pointing at the location of the user to be met and a distance value. Said functionality can be implemented at least in part by hardware components and software routines located either on User Equipment 165 or on Server 100.

Alternatively, the system might have predefined indoor or outdoor meeting locations memorized and stored either on Memory 102 or on Memory 433. Users can be routed to those locations to meet for face-to-face gathering by said algorithm. User Equipment 165 may also include an I/O User Interface 450. I/O User Interface 450 may allow inputting of information and data via a touch screen or a QWERTY keyboard.

In one implementation, I/O User Interface 450 may also include a vibrating notification module, a speaker, a monitor, or any combination thereof. User Equipment 165 may include one or more Transceiver 460 configured to operate in conjunction with one or more Antenna 470 to communicate wirelessly. In one embodiment, the Antenna Unit 470 may support beam forming and/or multiple input multiple output (MIMO) operations. As those skilled in the art know, MIMO operations may provide spatial diversity, which is to overcome difficult channel conditions and/or increase channel throughput. The Antenna 470 may include antenna tuning and/or impedance matching components, RF power amplifiers, and/or low noise amplifiers. User Equipment 165 can be optimized to support multiple transceivers using multiple wireless standards.

In one example embodiment, User Equipment 165 may support simultaneous transmission of cellular (for example, GSM, UMTS, LTE, WiMAX) and non-cellular (for example, WLAN 495 or Bluetooth®/ZigBee 490) radio carriers. A Transmission Module GSM/UMTS/LTE/WiMAX 475 may allow User Equipment 165 to communicate with Server 100.

The locationing component of the invention can be advantageously implemented in many different ways. In one possible implementation, a GPS Module 410 may provide the location of User Equipment 165 to Server 100 via Link 141. When in closed environments, such as a shopping mall, the location data can be provided via different techniques. For example, choke points or grids, location indexing and presence reporting for tagged objects such as RF-ID tags in user equipment such as User Equipment 165 or RF-ID bracelets, can be used to provide location data when indoor. Other examples of techniques used to provide location are angle of arrival, time of arrival and received signal strength indication. One aspect of the locationing component of the invention can be advantageously implemented by using a technique that will be described in FIG. 8.

The person skilled in the art will understand that not all the modules that are described are necessary to implement every embodiment but rather different embodiments can be implemented by using small subsets of the modules that have been described in FIG. 4. For example certain embodiments of the invention can be implemented by a using an RF-ID tag equipped bracelet.

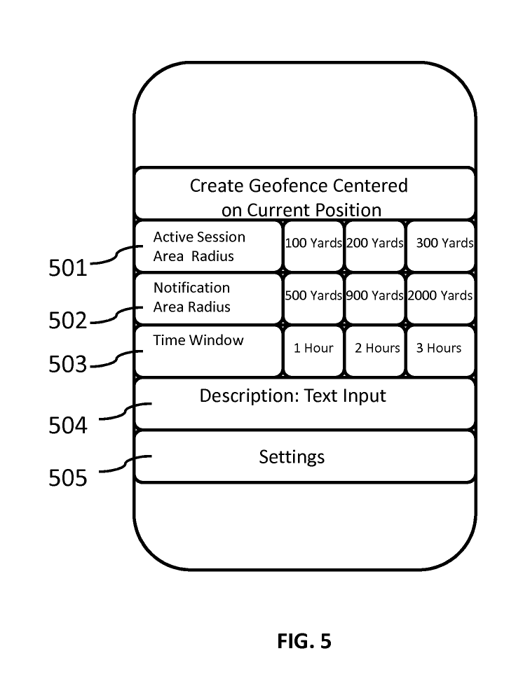

FIG. 5 describes one embodiment user interface screen that may pertain to User Equipment 160, 165, 170, and enables the implementation of a new functionality. In certain implementations, it could be advantageous to provide users with the possibility to quickly set up geofences wherever they are currently located and engage or notify other nearby users expeditiously.

Said functionality can be customized with predetermined parameters such as Active Session Area Radius 501, Notification Area Radius 502 and Time Window 503, i.e. the duration of the active session. In certain implementations, some or all of the above-mentioned settings can be predetermined to favor immediacy.

In one embodiment, geofences can be disconnected and independent from a physical location such as a building or a house but rather a geofence can be created in open spaces such as parks or parking lots for example. The field Event Description 504 can be used to input free text to describe details of the event or the purpose for the geofence.

Settings 505 can be used to create filters for the event such as the kind of users that will be notified in the notification zone such as, e.g., users belonging to a particular group in LinkedIn. In another implementation, Setting 505 can be used to regulate the visibility for the event. Certain events could be made discoverable and therefore accessible only to certain classes of users, or to predetermined users such as users belonging to particular groups in LinkedIn, or to selected users via an invite.

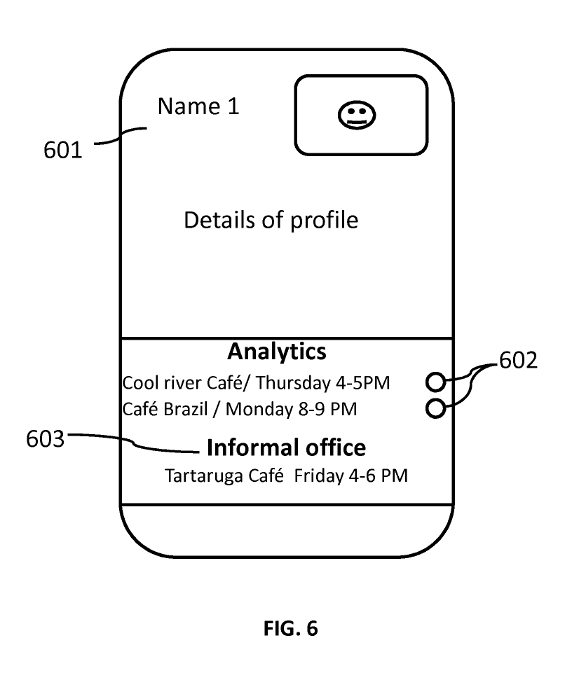

FIG. 6 describes one embodiment of a user interface screen that may pertain to User Equipment 160, 165, 170, and enables the implementation of new functionalities. Subscreen 601 may provide general details pertaining to user A. In certain instances, and subject to certain privacy settings, it could be beneficial for user A to allow user B to know places where he spends some of his time in public settings so that people who want to meet him or interact with him in the future may have an opportunity to do so. This information can be captured in Analytics Fields 602. In one implementation, it is a product of analytics that are made available by the system within the privacy settings imposed by user A.

In a certain implementation, a profile can also show a preset place that user A might have elected as his informal office via an Informal Office Field 603. The informal office can be an extension of formal business premises into public places, such as a happy hour place, that certain user my employ to attract new prospective clients. User A may pledge to be in his own informal office during the time window he indicates or whenever User A feels like turning on the notification that he is now in his ‘informal office” and he is available for informal interactions pertaining his profession. Server 100 may have stored in Memory 102 a list of informal offices that are associated with certain professional categories of users.

The person skilled in the art will understand that the same information and functionalities described with reference to FIG. 6 can be represented via a web browser or a flash application, in either a mobile or a fixed computer.

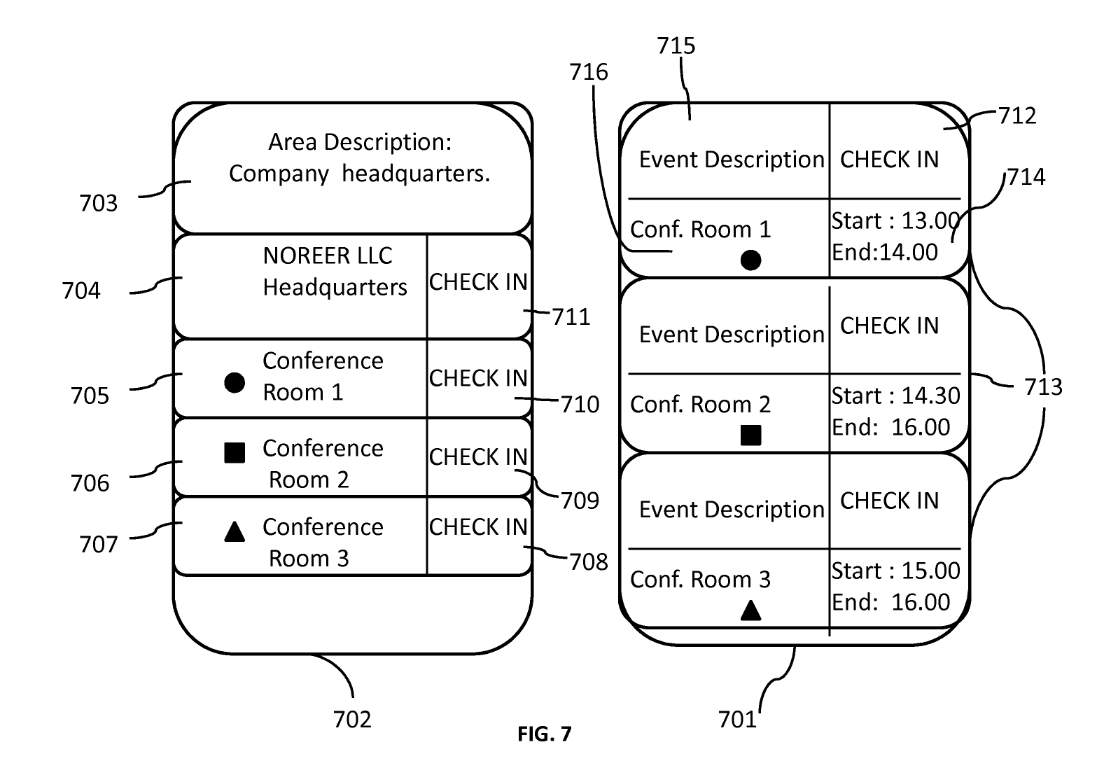

FIG. 7 describes embodiments for a user interface screen that may pertain, e.g., to User Equipment 160, 165, 170. Sometimes an indoor positioning system might be unavailable or it might be convenient to join a subset of active users within a session area manually. The person skilled in the art will understand that the example of touch screen is just explanatory. The same concepts can be reused across different user interfaces that are currently available or that will be available in the future such as virtual reality displays.

In one implementation, Session Area 190 may cover a whole business building or a convention center without any reference to subareas within said Session Area 190. Subareas might consist of predetermined conference rooms, floors and locations that can be used to partition Session Area 190 and to group together conveniently the users that are active and located within said subareas.

In one implementation, based on location and described with reference to Screen 702, the system may allow users within Session Area 190, e.g. a corporate building or a convention center, to check into the broad Session Area 190 by using a General Check In 711.

Multipurpose Screen 703 may provide information related to the location by pressing any of Buttons 704, 705, 706, 707. In the case represented in FIG. 7, Multipurpose Screen 703 is showing information related to Button 704.

In one implementation, subareas (or physical locations) within Session Area 190 can be labeled with symbols or colors. In the example of FIG. 7, Conference Room 1 is represented by a circle and any user physically approaching said Conference Room 1 can be reminded to check in into said subarea by means of a circle sign that can be located, e.g., at the entrance of said conference room. In the case of FIG. 7 said check in may occur by means of Button 710. The person skilled in the art will understand that similar scenarios are possible for conference room 2 and conference room 3 by using Button 709 and 708.

In another implementation, based on time, and described with reference to Screen 701 the system may list Events Tiles 713 related to events that are occurring within Session Area 190. Said Event Tiles 713 can be organized according to Time Window Tile 714. Event Tiles 713 may also display Event Description 715 and Event Location 716. The checking in can be permitted via check in functionalities such as the one described in Button 712 if the actual time is comprised within the time window described in Time Window Tile 714.

FIG. 8 describes a method to create and arrange a list of users as, e.g., the list described in FIG. 3 at Screen 300 according to proximity. This method may use, e.g., one of the locationing technologies that have been mentioned in the present application or the applications and patents that have been incorporated by reference. In one embodiment, Session Area 190, having Radius 182 and centered on Location 180, is subdivided in subareas having the shape of a square. Said subareas have been numbered consecutively from 1 to 36 for convenience. By subdividing a large session area in smaller subareas, the system may allow user A, who is e.g. located in subarea 16, to see other active users who are also located within subarea 16. The person skilled in the art will understand that the geometrical shape of the subareas may vary and that the example of squares is just one of many possible embodiments. Geometrical patterns may vary as many geometrical figures can be used. In one embodiment, patterns made of a combination of different figures can be used such as, for example, hexagons and pentagons.

With reference now to FIG. 3, the list of Users 301, 302, 303, 304, 305, 306 may represent users who are positioned within the same subarea. Subareas may, as indoor locationing and geofencing technology advance, represent rooms or indoor physical perimeters.

In another implementation, list of Users 301, 302, 303, 304, 305, 306 may represent not only users who are positioned in subarea 16 but also users who are positioned in adjacent subareas, e.g., subareas 17, 11, 10, 9, 15, 21, 22, and 23 as depicted on the left side of FIG. 8.

In one implementation, the list may maintain certain users and drop others if a user moves, for example, from subarea 16 to 21. This implementation avoids the complete refreshing of the list every time a user changes his position from a subarea to another. As a matter of example, in this implementation, if user moves from subarea 16 to 21 the new refreshed list of proximate users may comprise users who are positioned in subareas labeled 21, 22, 16, 15, 14, 20, 26, 27 and 28. In practice, every time a user is one subarea the system may show not only the users who are within the same subarea but also the users who are in the adjacent subareas.

In another implementation, the list of nearby users can be organized so that it will show first users who are located within the same subarea and then users who are located in surrounding subareas.

In another implementation, the list may comprise not only users who are in the same subarea and users who are located within a first level of surrounding subareas but also users who are located in a second level or third level of surrounding subareas as concentric regions expand to cover the whole Session Area 190.

In another implementation, represented schematically on the right side of FIG. 8, the refreshing of the list of users who are positioned within the same subarea may happen according to a certain algorithm that may prevent the jittering of said list when a user is located in proximity of a line that is demarcating two subareas. The system may employ, e.g., Hysteresis Bands 811 and 810 to dampen the jittering of the list of nearby users.

If a user moves from Point 801 to Point 804, the refreshing of the list may happen only when Point 803 is reached. If, on the contrary, user moves from Point 804 to Point 801, the refreshing of the list may happen only when user reaches Point 802 that is outside of the hysteresis guard bands. The person skilled in the art will understand that many modifications are possible to the usage and application of the concept of Hysteresis Bands 811 and 810.

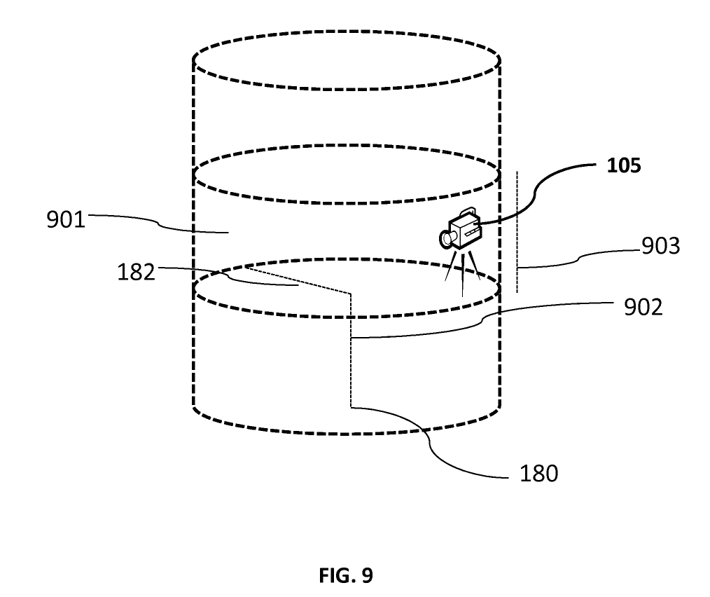

FIG. 9 illustrates the concept of geofencing applied to a three dimensional shape.

An altimeter is an instrument that relies on atmospheric readings to determine altitude over mean sea level, known as MSL. This can be done generally in one of three ways: measuring local air pressure with a barometer, bouncing radio waves off a target and calculating how quickly they are reflected or triangulating signals from three satellites using GPS. However, GPS triangulation can be difficult indoor or when all the satellites are close to the horizon.

At the time this application is written, altimeters such as, e.g., the Xtrinsic MPL3115A2 pressure sensor by a company named Freescale can provide a 30 cm resolution, which enables user equipment to identify elevation at a granular level. User Equipment 165 equipped with an Altimeter 478 module could detect the exact floor a user is on within a high-rise building or a shopping mall, allowing location-based services to reflect immediate surroundings accurately.

Latitude and longitude values for Location 180 plus Radius 182 can define a circular and exemplary two-dimensional geofence such as Session Area 190. As the state of the art of digital altimeters progresses, the two dimensional Session Area 190 may become a three dimensional figure such as Geobox 901 that can be represented not only by a latitude and a longitude value plus a radius but also by an Elevation 902 value and a Height 903 value. The person skilled in the art will understand that a plurality of Geoboxes 901 can be staked one on top of the other and different Elevation Values 902 can be representative of different floors in a building.

In one implementation, multiple session areas can be active on the same or different floors of the same building. In another implementation, Geobox 901 can be three dimensional while being associated to a two-dimensional notification area. In another implementation, both the session area and the notification area can be three-dimensional. For example, a notification area may reach out to lower floors and attract users to an active session within Geobox 901. The person skilled in the art will understand that Geoboxes could map and cover differ floors of an high rise building and provide different active sessions and all the functionalities that have been described in this application. Geoboxes can also coexist in the same space and time window. In one implementation, a Video Camera 105 can be contained within Geo Box 901 for an External User 112 to interact with active users who are within the active session area.

FIG. 10 describes an embodiment that allows External User 112 to interact with users who are within a remote session area. As discussed with reference to FIG. 1, in one implementation, Visual Field 1001 of Video Camera 105 can be correlated and mapped against the position of the users who are within said Visual Field 1001. The system, e.g. by knowing the position of the active users, can generate ID Icon 1005 and ID Icon 1004 that can be superimposed on Video Camera 105's video feed so that ID Icon 1005 and ID Icon 1004 can overlap with, e.g., the moving images of the users of , e.g., User Equipment 160 and 165 within Visual Field 1001.

In one implementation, said ID Icon 1005 and ID Icon 1004 can be superimposed on top of the faces of active users by using face detection technology. This technology may use special algorithms to parse Visual Field 1001 looking for the shape of a human face. Face detection technology is described in several patents and applications such as U.S. Pat. No. 7,203,346 B2, U.S. Pat. No. 8,457,367 B1, US20080247611, US20100135541 A1, WO2010043771 A1 and WO2011042601 A1. The combination of face recognition with the location awareness of active users within the session area by the system makes it possible for the system to generate virtual icons that can be used to interact with those users via, for example, a touch screen.

In the example of FIG. 10, User 1002 is associated with ID Icon 1004 and User Equipment 165 while User 1003 is associated with ID Icon 1005 and User Equipment 160. Data associated with User equipment 165 and 160 is stored on Server 100. By acting upon ID Icon 1004, External User 112 can extract or store information related to User 1002 by means of Info Menu 1007.

In one implementation, since the system is storing user profiles, settings and information related to User Equipment 160 and 165 on Server 100, external User 112 could interact with users within Session Area 190 by acting upon said ID icons. For example, External User 112 could express interest in meeting in the future with a particular user associated with User equipment 160. Alternatively, External User 112 can interact real-time with a particular user associated with User equipment 160 by pushing a message or a notification by means of Interaction Menu 1008.

One of the possible scenarios for this embodiment could be a dating scenario wherein External User 112 would be able to remotely access public places and observe or interact with prospective dates in a bar from his remote location. In another implementation, during a conference, External User 112 could be able to interact with selected members of a panel. The person skilled in the art will understand that the scenarios are very diverse and that users may adjust their privacy settings so that this functionality can be enabled or disabled.

In one implementation, User Equipment 165 and 160 may include an RF-ID tag while Video camera 105 may include an RF-ID interrogator so that the response from the RF-ID tag can be used by the system to generate said ID Icon 1005 and 1004. In this implementation, the direction of interrogation of the RF-ID interrogator and the time of arrival of the response received can be used to produce the above-mentioned correlation with Visual Field 1001. The dimensions of said ID Icon 1005 and ID Icon 1004 can be scaled according to the calculated distance from said Video Camera 105 to provide a three-dimensional perspective to External User 112.

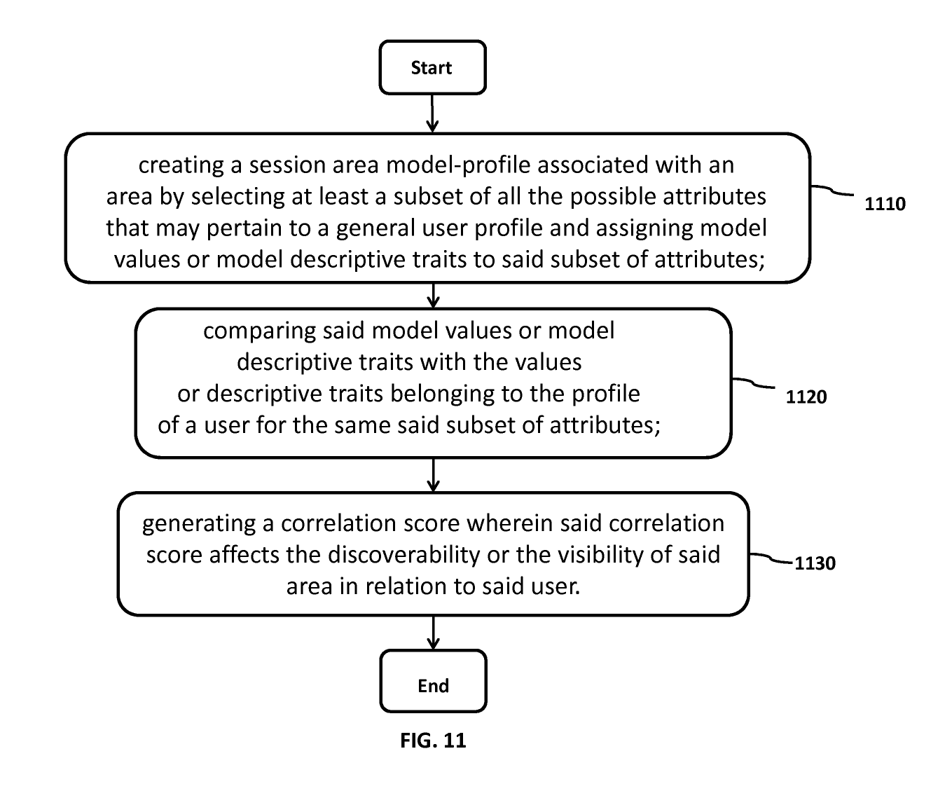

FIG. 11 represents a flow chart illustrating a possible embodiment of a method for allowing selective discoverability and visibility of events and areas according to the degree of correlation between users' profiles and an area profile (i.e. “session area model-profile).” The person skilled in the art will understand that discoverability and visibility of session areas or events should be interpreted broadly. In one implementation, events and session area can be discoverable or visible by not only using a dedicated mobile application but also by using a web browser in a fixed or mobile computer equipment.

A representative method embodiment of the present invention comprises: 1) “creating a session area model-profile associated with an area by selecting at least a subset of all the possible attributes that may pertain to a general user profile and assigning model values or model descriptive traits to said subset of attributes”, Step 1110; 2) “comparing said model values or model descriptive traits with the values or descriptive traits belonging to the profile of a user for the same said subset of attributes”, Step 1120; and 3) “generating a correlation score wherein said correlation score affects the discoverability or the visibility of said area in relation to said user”, Step 1130.

As discussed in previous sections, the term “session area model-profile” can often be used interchangeably with an “event model-profile”. An “event” can be an occurrence, usually limited in time, anchored, at least provisionally, to a specific session area location. For the sake of simplicity and consistency, the term “session area model-profile” has often been used to represent both, the spatial dimension and the temporal dimension, since a session area model-profile may be characterized by a predefined temporal window of activity associated to an event.

The person skilled in the art will understand that the term “correlation”, “correlation score” or “correlation output” should be interpreted broadly since the attributes forming a profile (either a user profile or an area model-profile) can belong to very diverse and non-homogenous classes. For example: 1) To define “correlation” numerical values representing a continuum of possible data can be used. Those data can be compared to a numeric benchmark, e.g., Age. 2) A discrete data flag (e.g., a “yes” or “no” to a determined condition) can be used, e.g., Married. 3) A descriptive trait like Profession=“Doctor “can also be used. 4) A code that a user has inserted in a dedicated field can be used. A correlation output can be, in some instances, a weighted combination of different data pertaining to very different kind or classes of attributes.

In one implementation, if an area has been dedicated to a certain LinkedIn group or other social groups, it can be discoverable only by members of that group. For the purpose of this application, both the discrete/descriptive data and the continuum data are examples of how to achieve or gauge “a correlation output.”

In another embodiment, correlation scores, correlation thresholds, and correlation benchmarks may adjust according to how many users have a profile that reaches a minimum degree of correlation with said session area model-profile to produce a best effort result.

In one implementation, an algorithm may produce a “best effort” group of users and generate a minimum or a predefined number of users whose profiles correlate the most with a desired user profile for an event or an area. Said desired profile can be represented by the session area model-profile. Said algorithm may 1) run a search among user profiles, 2) benchmark those user profiles against the desired session area model-profile 3) establish certain variance boundaries attributes to include a minimum number of prospective active users for the session area.

In one implementation, said algorithm might consider the location of the session area and adjust 1) either the radius of discoverability or 2) the variance boundaries around the session area model-profile or 3) do both.

A service operator can also implement said method manually. Said operator, by varying the variance boundaries, can generate a desired number of prospective active users for a session area associated with a desired “session area model profile”.

Embodiments of the present invention may be implemented in software, hardware, application logic or a combination of software, hardware and application logic. The software, application logic and/or hardware may reside on mobile computer equipment, fixed equipment or servers that may not always be owned or operated by a single entity as described by the example of Administrator Equipment 110 or Fractional Administrator Equipment 111. If desired, part of the software, application logic and/or hardware may reside on multiple servers and equipment in charge of different processes.

In an example embodiment, the application logic, software or an instruction set is maintained on any one of various conventional computer-readable media. In the context of this application, a “computer-readable medium” may be any media or means that can contain, store, communicate, propagate or transport the instructions for use by or in connection with an instruction execution system, apparatus, or device, such as a computer, with examples of computers described and depicted in FIGS. 1 as 100, 110, 111, 112, 160, 165 and 170.

A computer-readable medium may comprise a computer-readable storage medium that may be any media or means that can contain or store the instructions for use by or in connection with an instruction execution system, apparatus, or device, such as a fixed or mobile computer.

If desired, the different functions discussed herein may be performed in a different order and/or concurrently with each other. Furthermore, if desired, one or more of the above-described functions may be optional or can be combined. As technology advances, new equipment and techniques can be viable substitutes of the equipment and techniques that have been described in this application.

Although various aspects of the invention are set out in the independent claims, other aspects of the invention comprise other combinations of features from the described embodiments and/or the dependent claims with the features of the independent claims, and not solely the combinations explicitly set out in the claims. The above described example embodiments of the invention should not be viewed as limiting but merely as explanatory.

The person skilled in the art will understand that are several variations and modifications, which can be made without departing from the scope of the present invention as, defined in the appended claims.

What is claimed is:

1. A method comprising:
creating a session area model-profile associated with an area by selecting at least a subset of all the possible attributes that may pertain to a general user profile and by assigning model values to said subset of attributes;
comparing said model values with the values belonging to the profile of a user for the same said subset of attributes; and
generating a correlation output.

2. The method of claim 1 wherein said correlation output can be adapted via correlation weights associated with at least some of said subset of attributes.

3. The method of claim 1 wherein said correlation output affects the discoverability of said area associated with said session area model-profile by said at least one user.

4. The method of claim 1 wherein said correlation output affects the discoverability of said at least one user by other users who are associated with said area.

5. The method of claim 1 wherein said correlation output affects the visibility of said at least one user in relation to other users who are associated with said area.

6. The method of claim 1 wherein said correlation output affects at least one of the functionalities associated with said area that are potentially available to said at least one user.

7. The method of claim 6 wherein said at least one of the functionalities is related to the capability of interacting with other users.

8. A computer software system having a set of instructions stored in a non-transitory computer-readable medium for controlling at least one general-purpose digital computer in performing desired functions comprising:
a set of instructions formed into each of a plurality of modules, each modules comprising:
a process for creating a session area model-profile associated with an area by selecting at least a subset of all the possible attributes that may pertain to a general user profile and by assigning model values to said subset of attributes;
a process for comparing said model values with the values belonging to the profile of a user for the same said subset of attributes; and
a process for generating a correlation output.

9. The computer software system of claim 8 wherein said correlation output can be adapted via correlation weights associated with at least some of said subset of attributes.

10. The computer software system of claim 8 wherein said correlation output affects the discoverability of said area associated with said session area model-profile by said at least one user.

11. The computer software system of claim 8 wherein said correlation output affects the discoverability of said at least one user by other users who are associated with said area.

12. The computer software system of claim 8 wherein said correlation output affects the visibility of said at least one user in relation to other users who are associated with said area.

13. The computer software system of claim 8 wherein said correlation output affects at least one of the functionalities associated with said area that are potentially available to said at least one user.

14. The computer software system of claim 13 wherein said at least one of the functionalities associated with said area that are potentially available to said at least one user is related to the capability of interacting with other users.

15. An apparatus, comprising:
at least one processor; and at least one non-transitory computer-readable medium including a computer program code; the at least one non-transitory computer-readable medium and the computer program code configured to, with the at least one processor, cause the apparatus to perform at least the following:
creating a session area model-profile associated with an area by selecting at least a subset of all the possible attributes that may pertain to a general user profile and by assigning model values to said subset of attributes;
comparing said model values with the values or descriptive traits belonging to the profile of a user for the same said subset of attributes; and
generating a correlation output.

16. The apparatus of claim 15 wherein said correlation output can be adapted via correlation weights associated with at least some of said subset of attributes.

17. The apparatus of claim 15 wherein said correlation output affects the discoverability of said area associated with said session area model-profile by said at least one user.

18. The apparatus of claim 15 wherein said correlation output affects the discoverability of said at least one user by other users who are associated with said area.

19. The apparatus of claim 15 wherein said correlation output affects the visibility of said at least one user in relation to other users who are associated with said area.

20. The apparatus of claim 15 wherein said correlation output affects at least one of the functionalities associated with said area that are potentially available to said at least one user.
